(19) United States
(12) Patent Application Publication
(10) Pub. No.: US 2002/0088898 A1
(43) Pub. Date: Jul. 11, 2002

(54) Airborne fire fighting system

(76) Inventor: John C. Lucy, Exeter (GB)

Correspondence Address: S. Pal Asija, 7 Woonsocket Ave, Shelton, CT, 06484, US

(21) Appl. No.: 09/736,468

(22) Filed: Dec. 15, 2000

(30) Foreign Application Priority Data
Dec. 16, 1999 (GB) 9929656.8

(51) Int. Cl. B64D 27/20; B64C 27/82; A62C 3/02

(52) U.S. Cl. 244/17.11; 244/56; 169/70

(57) ABSTRACT

Airborne fire fighting system comprising a helicopter and a pair of tiltable jet engines where the exhaust can be directed at the fire under the control of the pilot or other fire fighting crew. AFFS comprises a rotor-powered craft, fitted internally with a jet engine collinear to the length of the fuselage which has an air intake projecting through the rear of the fuselage. The jet exhaust escapes through a vector able orifice, protruding through the floor of the fuselage of the airborne firefighting platform. The jet exhaust impacts the ground in front of an advancing firewall and bounces through the firewall, extinguishing that segment of the fire. The system can also be used is to disperse snow and ice. The jet engine may also be removed and a smaller jet engine affixed with hydraulic arms to a wheeled mobile to be loaded into the AFFS and delivered to a fire zone where it can used to extinguish fire by remote control.

### BACKGROUND

This invention relates to methods, devices and systems for extinguishing ground fires. More particularly it relates to an airborne firefighting system. Even more particularly it relates to extinguishing huge wild fires by exhaust from tilt able Jet engines mounted on helicopters.

### THE PROBLEM

The problems with prior art fire fighting systems is that are inadequate for controlling fires that have recently been experienced on this planet. Large-scale fires devastate many thousands of acres of forest and wilderness throughout the world each year. In the U.S. alone, some 4,700,000 acres were wasted in just the first nine months of 1999. Such fires may be left to burn out naturally but often the blazes generate such ferocity and breadth that action has to be taken. This may entail the drafting in of many thousands of fire fighters. In wilderness areas a ready supply of water may be too far to be of help and the fire crew's strategy then is to construct ‘firebreaks’.

During December 1997 in Australia, a vast swathe of land, some 350 kilometers in length was reckoned to have as many as 400 separate fires blazing. Ten thousand volunteers and crews were attempting to contain the fires but such was their onward momentum, the infernos eventually swept into the Sydney suburbs destroying many fine irreplaceable houses. Only heavy downpours of rain prevented a catastrophe.

Fires burning in Florida, U.S.A. during 1998 were also too numerous for fire crews to cope with. It was reported that for each fire extinguished, another five started. The fires continue to burn during several months despite efforts of the fire crews. The southern states of the U.S. maintained scorching heat for over a month in 1998 and for over two months in 2000. The temperature at Dallas, Tx. stayed above 37.6 centigrade for over a month. 1998 and in year 2000 the temperature stayed in triple digits of Fahrenheit scale for two months.

This is now a new record as the planets hottest year in the last thousand years of history and the 1990′ have been the hottest decade in the last 600 years.

Recent fires in Montana in USA have made the mankind humble about its ability to fight fires to the extent that they are now researching ways to replace wildly growing combustible cheat grass with some fire resistant or retardant strain of grass. In the mean time the problem of uncontrolled fires continues.

If global-warming continues to accelerate as scientists predict there is a good chance that there will be a proliferation of fires beyond that which we have so far witnessed. While many fires are started by nature, many are the result of lightning striking the earth or trees but many are the result of a careless act by man. Even worse are deliberate acts of arson.

Education and publicity can play a part in diminishing man's contribution to worldwide conflagration but man must find some new way to ameliorate the surge of these monster blazes. Their forward momentum can reach quite incredible speeds, rivaling an avalanche and covering many kilometers in a twenty-four hour period. Some force of man must be found to provide a remedy to the havoc wreaked by the forces of fire.

At the conclusion of the Gulf war in 1990, the deserts of Kuwait were a mass of burning oil wells. Specialist fire fighting teams were brought in to control and extinguish the blazes. Most of the fires were stopped using strong explosive which required to be sited as close to the oil head as possible for an effective blowout. On several occasions a jet engine, strapped to the back of a truck, was observed being backed up to one of the blazing oil heads. The jet engine was ignited and the blast emanating from the exhaust orifice, directed at the base of the blaze. The jet blast immediately punched out the power of the blaze or denied it air to Continue Its ignition. The conclusion is that here is the basis for a method to extinguish the power of a static flame and also mobile infernos such as those rampaging across wilderness or mountain regions.

Snow and ice frequently cause major problems for both private individuals and public authorities. Airport runways are deemed to be unserviceable after or during heavy snowfalls. Snowfalls are the main means of keeping runways and perimeter service lanes open but the huge acreage involved is often too much for the snow ploughs and the only option is to close down the airport.

Where snow falls continuously on a major roadway, big drifts start to build quickly which creates huge disruption on a motor-way with a heavy traffic flow. Snowploughs are the only means to transpose the drifts to the roadside. A situation may occur where the snow piles up behind the plough faster than it clears the drift in front of it. Ice too will bring traffic to a halt when vehicles slide into each other and form a blockage to the following vehicles.

Roads are frequently laid on the floor of valleys where mountains rise up on either side. They may also be sited halfway up a mountainside. In winter conditions where snow builds up in the higher slopes of the mountains, such roads are subject to avalanches of snow sliding down the slope and dumping many feet of snow on the road. The clearance of such snow slides entails many hours of work for whatever snow ploughs are available and it may be days before the traffic starts to flow again. In the meantime all traffic must be rerouted unless no other road is left open. Ice often builds up thickly on the exposed areas of marine craft. The rigging is particularly susceptible to ice attack and may in extreme cases cause the vessel to capsize; Aircraft are also subject to layers of ice building up while standing on the ground. Outdoor machinery may often freeze up in extreme weather. It may be sited in locations difficult to access or it may be dangerous for men to get to in order to break up the ice.

Power lines and their supporting pylons are particularly vulnerable to ice. In Canada, during the winter of 1998, a series of ice storms put such weight on one area of cables and pylons that they collapsed or buckled, curtailing all electric supplies throughout a large urban area.

Radio and TV masts are often located on highly exposed sites where they are liable to severe icing in winter periods. When the ice reaches a critical thickness transmissions become impossible. Where ice builds up on bridges, it can become hazardous for the passage of both vehicles and pedestrians. Ice may build up around a vessel at sea restricting all further movement. If the restriction extends for some time it may prove costly to the vessel's owners.

A recent device fitted to a helicopter can pump or suck 4,500 liters into a basket in just sixty seconds. While such a device is of great benefit in many cases of fire dousement where accuracy is required, the quantity of water delivered falls far short of the amounts needed to actually extinguish all the fire in a large-scale wilderness blaze.

The extent and spread of these fires means that fire crews are often forced to abandon the fire zone and hope that rain will arrive to extinguish what they could not.

### SUMMARY

The airborne fire fighting system of this invention, as the name implies, comprises a helicopter and a pair of tilt-able jet engines where the exhaust can be directed at the fire under the control of onboard pilot or remote radio control.

In an embodiment jet is placed inside the fuselage, intake to rear, engine body tilted down to exit exhaust through a hole in the pod floor. The exit is centrally located under the main rotor. The exhaust is ‘vectored’ or angled to give the operator and the crew flexibility. According to the present invention, a portion of the thrust of the jet engine is diverted and piped along metal conduits to orifices located at strategic points both fore and aft on both sides of the fuselage and beneath, to stabilize the AFFS when the craft is preparing to become operational or altering mode during operational procedures. The thrust from the orifices will thus prevent excessive pitch and yaw.

### PRIOR ART

A preliminary prior art patentability search was conducted. Furthermore the inventor is intimately familiar with the prior art. Following are typical examples of the prior art known to the applicant arranged in the reverse chronological order for ready reference of the reader.

10) “The Hawaiian Fire Department Jet Powered Fire Truck” www.Jetfiretruck.com

09) United States Non-Provisional Utility Patent 6,003,782 granted to Kim et al on Dec. 21, 1999 for “Aerial Spray System”

08) United States Non-Provisional Utility Patent 5,590,717 issued posthumously to McBay et al on Jan 7, 1997 for “Fire Extinguishing Capsule”

07) “NASA Lear Jet Assists US Fire Service Fire Fighters” NASA Ames Research Center News Release on May 10, 1996.06) 06) United States Non- Provisional Utility Patent 5,411,397 bestowed upon Rogers et al on May 2, 1995 for “Aircraft Fire Fighting Trainer Having a Mixture of Liquid and Aggregate Particles as a Fuel Diffuser”

05) United States Non-Provisional Utility Patent 5,275,244 published in the name of Fernando Da Silva on Jan 4, 1994 for “Apparatus and Process for Extinguishing Fires with a non-combustible Fluid in Liquid and Gaseous States”

04) United States Non-Provisional Utility Patent 5,165,484 earned by Victor Chaput on Nov 24, 1992 for “Oil Well Fire Extinguisher Having Oil Jet Dispersing Screens”

03) United States Non-Provisional Utility Patent 4,770,794 honored upon Cundasawmy et al on Sep 13, 1988 for “Foam Fire Extinguishing Compositions for Aerial Fire Extinguishing”

02) United States Non-Provisional Utility Patent 4,722,766 presented to David Spring on Feb 2, 1988 for “Extinguishing of Fires and Explosions”

01) United States Non-Provisional Utility Patent 4,614,237 earned by Colodner et al on Sep 30, 1986 for “Combination Exhaust Gas Fire Extinguisher and Blower Machine”

Unfortunately none of the prior art devices singly or even in combination provide all of the features and objectives established by the inventor for this system as enumerated below.

### OBJECTIVES

1. It is an objective of this invention to provide method, devices and system for preventing, controlling, managing and extinguishing fires quickly and effectively from exhaust blasts of tilt-able jet engines mounted on helicopters.

2. Another objective of this invention is to provide an airborne platform for extinguishing fires in all types or terrain and circumstances.

3. Another objective of this invention is to provide means for controlling and extinguishing fires remotely.

4. Another objective of this invention is to quickly transport and replenish fire extinguishment equipment and supplies on site.

5. Another objective of this invention is that it be easy to use even intuitive that requires little additional training.

6. Another objective of this invention is that it be capable of multiple functions such as snow removal, riot control, highway sweeping etc.

7. Another objective of this invention is that it be environmentally friendly.

8. Another objective of this invention is that it be made of modular units easily interface-able to each other.

9. Another objective of this invention is that it meets all federal, state, local and other private standards, guidelines and recommendations with respect to safety, environment, and quality and energy consumption.

10. Another objective of this invention is that it permit landing and take off of large aircrafts in remote areas for replenishing of supplies, ammunition and personnel at the point or line of action without having to build and expensive runway.

11. Another objective of this invention is that it be elegantly simple in concept and design.

12. Another objective of this invention is that it be applicable to retrofit as well as OEM market.

13. Another objective of this invention is that it be easy to install, de- install, transport and store.

14. Another objective of this invention is that it be applicable to all types of aircraft and rotorcrafts for example airplanes, helicopters, drones etc.

16. Another objective of this invention is that it can be adapted for other uses such as extinguishing oil head fires, as was the need evident in Gulf War.

Other objectives of this invention reside in its simplicity, elegance of design, ease of manufacture, service and use and even aesthetics as will become apparent from the following brief description of the drawings and concomitant description.

### LIMITATIONS OF THE PRIOR ART

The prior art has used water; chemicals or just the natural breaks the forests. The breaks may be an avenue of chopped trees or just cleared brush. Another tactic is to ignite trees and foliage in the path of the oncoming blaze. When the flames arrive at the break, the two fires collide and self extinguish. In practice, the wind often changes the direction of the blaze or a burning break erupts into another contributory blaze. Flames often ‘leap’ breaks of considerable width. Fire fighters are confronted with the spectacle of a fire spreading from treetop to treetop, making control all but impossible.

Radio communication is an essential part of modern fire fighting but where the density of smoke has built to a blinding degree, it is not uncommon for the crewmembers to become confused or disorientated. They are often left with no avenue of escape and annual mortality rates are unacceptably high. Many deaths occur later as a result of smoke inhalation or burns. Dedicated aircraft, (usually flying boats with onboard water tanks) are employed by many countries. They have the facility to move across a lake or river, scooping up a large volume of water into the tanks without stopping. A dye is injected into the water and after a water drop; pilots can see where the land has been previously doused. Where strong crosswinds are blowing, it may be difficult to position the water where it is most needed. Also wind speed may reach a level where the aircraft are not allowed to take off. In 1999, fires in the south of France coincided with a strong ‘mistral’ blowing down the Rhone valley. The 100kph mistral grounded the water tankers for a considerable period.

The tanker flying boats are only able to drop 12,000 liters at one time and a large fire thus requires many of these tankers to keep up a continuous assault on the fire. If the available water supplies are some distance from the blazes, it will greatly hinder or slow down the fire fighting operations.

Electronic fire and heat detecting devices are now a standard fitment on fire fighting aircraft. Where excessive smoke obscures crew vision, the devices enable a chart of fire movement to be accurately obtained.

Helicopters are increasingly utilized in fighting fire. Water baskets are slung beneath the pod of the fuselage and by use of a hose dangling from the basket, they are able to suck water up into the basket while hovering above a water supply.

During December 1997 in Australia, a vast swathe of land, some 350 kms in length was reckoned to have as many as 400 separate fires blazing. 10,000 volunteers and crews were attempting to constrain the fires but such was their onward momentum, the infernos eventually swept into the Sydney suburbs destroying many fine irreplaceable houses. Only heavy downpours of rain prevented a catastrophe.

Fires burning in Florida, U.S.A. during 1998 were also too numerous for fire crews to cope with. It was reported that for each fire extinguished, another five started. The fires continued to burn during several months despite efforts of the fire crews. The southern states of the U.S.A. maintained scorching heat for over a month in 1998. The temperature at Dallas, Tx. stayed above 37.6 c. for over a month. 1998 is on record as the planet's hottest year in the last thousand years of history and the 1990's are the hottest decade in the last 600 years. If global warming continues to accelerate as scientists predict there is a good chance that there will be a proliferation of fires well beyond that which we have so far witnessed.

Fires are started by nature. Many are the result of lightning striking the earth or trees but many are the result of a careless act by man. Some are deliberate acts of arson. Education and publicity can play a part in diminishing man's contribution to worldwide conflagration but man must find some way to ameliorate the surge of these monster blazes. Their forward momentum can reach quite incredible speeds comparable to an avalanche and covering many kilometers in a 24hr period. Some force must be found by man to remedy the havoc wreaked by the immense forces of fire.

At the conclusion of the Gulf war in 1990, the deserts of Kuwait were a mass of burning oil wells. Specialist fire fighting teams were brought in to control and extinguish the blazes. Most of the fires were stopped using strong explosives. This required it to be sited as close to the wellhead as possible. On several occasions a jet engine, strapped to the back of a truck, was observed backing up to one of the oil heads. The jet engine was ignited and the blast emanating from the exhaust orifice directed at the base of the blaze. The jet blast immediately punched out the power of the blaze or denied it air to continue ignition. The conclusion is that this method is a basis to extinguish a powerful static flame and also moving infernos traversing wilderness or mountain regions.

### BRIEF DESCRIPTION OF THE DRAWINGS

The AFFS is not drawn to scale in any of the drawings.

FIG. 1 shows a side elevation of the AFFS

FIG. 2 shows the same side elevation as FIG. 1 cut away to reveal the jet engine installation in the fuselage pod and location of the stabilizer tanks.

FIG. 3 shows a plan view of the AFFS together with a front elevation.

FIG. 4 shows in diagrammatic form, the AFFS operating over a fire zone advancing over flat ground. The escape angle of the jet exhaust, the impact point and impact angle are shown. Also shown is the stretch of the strike zone in front of, and behind the impact point. A zigzag line through the jet exhaust denotes a foreshortening as it does in all other drawings. The AFFC is not drawn to scale in this or any other drawing.

FIG. 5 shows an elevation of the AFFS in operation over flat ground. The jet exhaust is illustrated striking the ground in front of a firewall and the resultant scatter of the fire debris through the flames

FIG. 6 shows various trajectories taken by the fire debris around the impact point where the jet exhaust gases escape perpendicularly from the AFFS

FIG. 7 shows an elevation and section of the strike zone on flat land and the trajectories of the fire debris both behind and in front of the impact point.

FIG. 8 shows diagrammatically, the ground gained by vectoring the jet exhaust through four forward escape angles. The ground distance is in scale to the altitude.

FIG. 9 shows a near vertical escape of exhaust gases in which flaming debris may be distributed equidistantly about the impact point. The debris scatter on unburnt land may create fresh ignitions.

FIG. 10 shows a plan form of the AFFC facing an advancing firewall. Also shown is the arc of the impact point where the AFFC is turned a few degrees to left and then right.

FIG. 11 shows in plan form the AFFC facing a firewall and the scatter of the flame debris through the length of the strike zone.

FIG. 12 illustrates an elevation through a moderate hillside where the AFFS is strafing down on a rising firewall.

FIG. 13 shows three scatter patterns of a jet exhaust on a moderate hillside where the exhaust escapes from the AFFS at different escape angles.

FIG. 14 shows an elevation through a long variable angled hillside where the AFFS is located over an adjacent valley.

FIG. 15 shows how the gradients of a moderate slope and steep hillside work to the advantage of the vectored jet exhaust compared to an escape above a flat surface.

FIG. 16 shows a plan view of some maneuvers the AFFS makes to address an advancing firewall.

FIG. 17 shows how a gradient may affect the AFFS relative to the downdraught and turbulence produced by the rotor vanes above a moderate hillside.

FIG. 18 shows an elevation through a steep hillside where the firewall is rising. The AFFS is moving lengthwise across the hillside.

FIG. 19 shows an elevation through a steep hillside where the AFFS as moved away from the excessive smoke plumes and is facing the hillside.

FIG. 20 shows the AFFS in action and how versatile it can be in various types of terrain and situations.

FIG. 21 shows the AFFS with the wheeled mobile about to be cable winched into the interior of the fuselage.

FIG. 22 shows a three-dimensional perspective of the mobile with stabilizing legs extended.

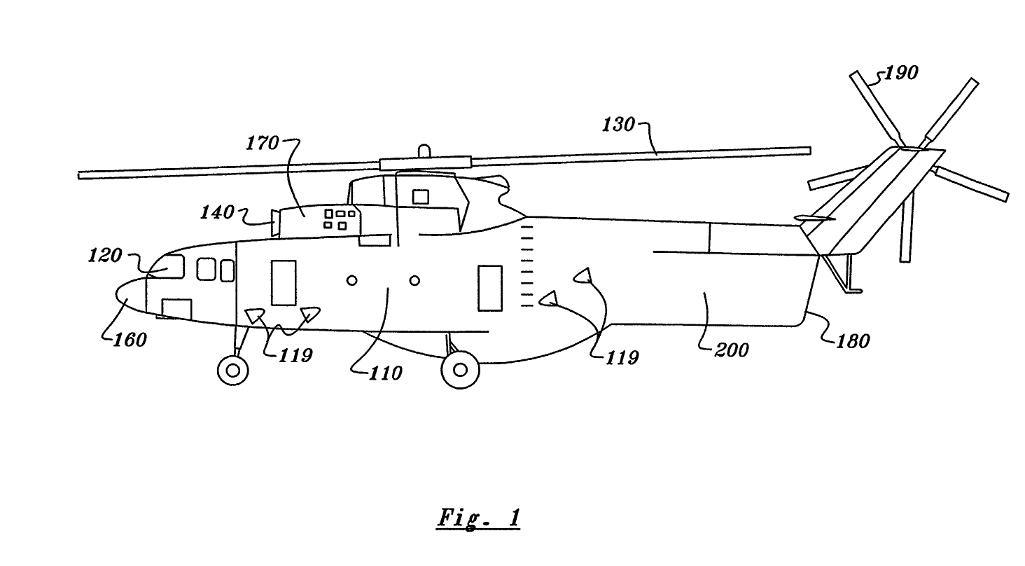

A specific embodiment of the invention follows relative to the operational functions of the AFFS. Procedures are outlined under the subheading of OPERATION at the end of this description of the preferred and alternate embodiments.

### DETAILED DESCRIPTION OF THE PREFERRED EMBODIMENT

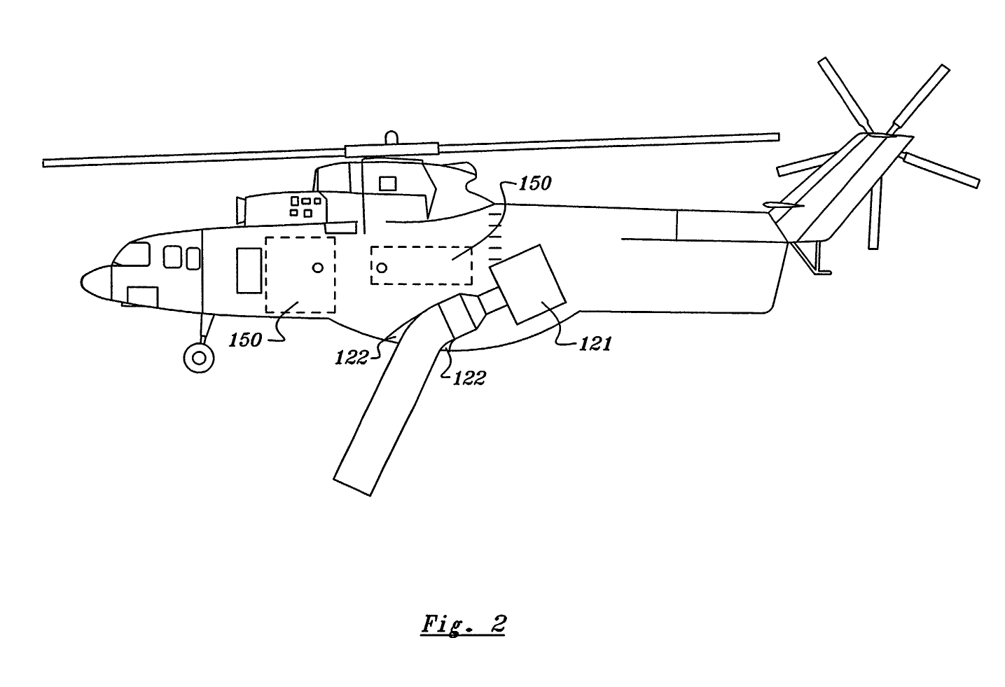

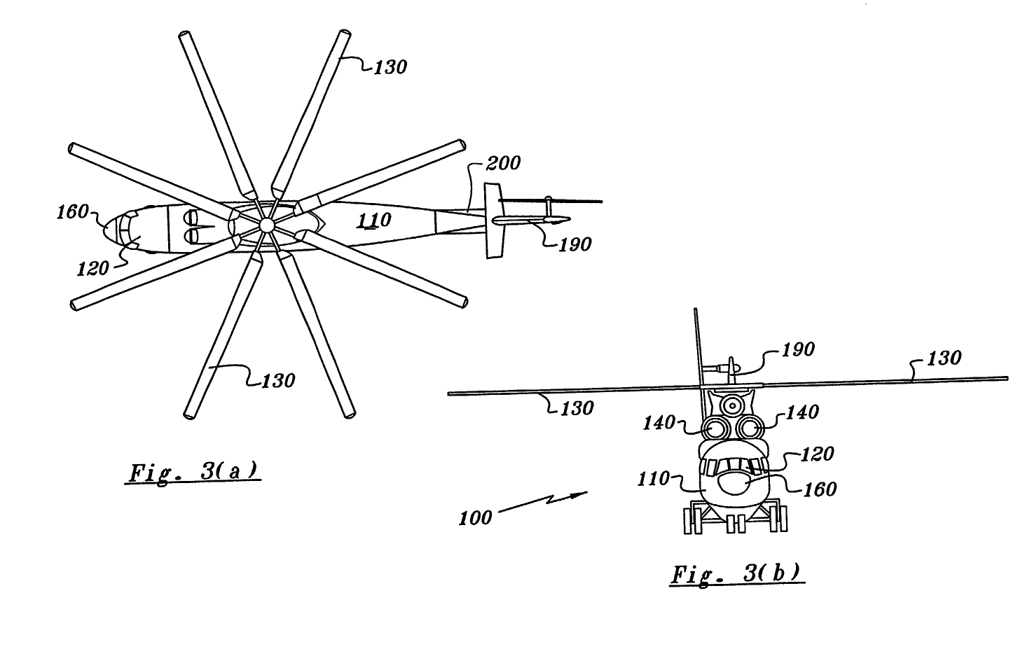

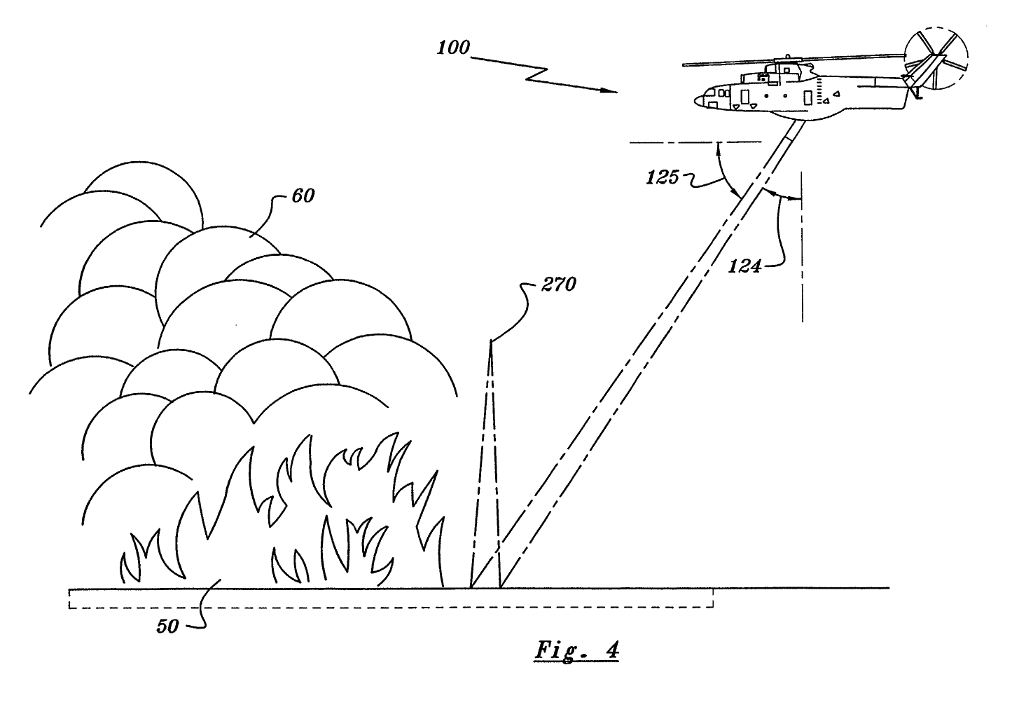

The airborne fire fighting system of this invention as shown in the various drawings wherein like numerals represent like parts throughout the several views, there is generally disclosed in FIG. I is side elevation of the AFFS. FIG. 2 shows the same side elevation as FIG. I to reveal the jet engine installation in the fuselage pod and location of the stabilizer tanks. FIG. 3 shows a plan view of the AFFS together with a front elevation. FIG. 4 shows in diagrammatic form, the AFFS operating over a fire zone advancing over flat ground. The escape angle of the jet exhaust, the impact point and impact angle are shown.

According to the present invention, an airborne fire fighting craft hereafter referred to as the AFFS comprises a semi-monocoque, metal fuselage of the ‘pod and boom’ category. The total length of the fuselage is 33.73 m. The height is 8.06m. Internally the fuselage pod has a length of 12m of holding space. The available width is 3.25m. Internal height about ten feet Two power plants each developing 10,700KW through free turbine, turbo shafts will jointly power through an eight tooth engagement gear box, a set of eight vanes. The power plants, gearbox and vanes sit on top of the pod section of the fuselage. The weight of the gearbox is 3,500kg and represents 12.4% of the empty weight of the AFFS. The gearbox can handle a maximum power of 14,710 KW so it is not possible to operate both engines at maximum power. In the event of failure by one engine, the remaining engine can be brought to full power. The AFFS is capable of hovering on one engine even when the gross weight is more than 40,000 kg. The empty weight of the AFFS is 28,200 kg. A useful payload is 48,200 kg. The maximum gross weight is 56,000 kg.

The dry weight of each engine powering the vanes or rotor blades in the preferred embodiment was 1,000 kg. The pressure ratio was 18.3 and maximum continuous power at 7,500 rpm was about 8300 KW. The power turbine inlet temperature was approximately 1200 degrees centigrade. The two engines, modular in design, are located side by side above the fuselage. Their cowlings are capable of being let down hydraulically to act as work platforms. The engine intakes are heated and deflectors protect the intakes from ingestions of harmful bodies. Further protection inside the engine intakes is provided by centrifugal particle separators. An air intake gives the gearbox, fan driven, cooling air. The intake is situated in between and above the engines and is well set back.

The set of eight rotating vanes, powered by the two power plants will provide lift and descent for the AFFS. Backward and forward movement is also be instigated by the lateral rotating vanes. Each vane is torsion ally rigid with simple tubular spars and manufactured as single pieces. Each has 26 glassfibre-covered and honeycomb-filled segments bonded to the spar. The vane tip is made from the same material and spins at 220 m/sec. The eight vanes rotate at 132 rpm. Each vane has a constant chord about I m and each vane tapers in thickness towards the tip. The leading edge of each vane has electro-thermal de-icing. The main rotor hub is made from a titanium alloy. Flapping, drag and feathering hinges are present together with droop stops and hydraulic drag dampers. The eight vanes weigh only 2000 kg and their diameter is 32 meters.

From the pod of the fuselage extends a tail boom projecting to the rear of the pod. It will project from the top of the pod beyond the circumference of the lateral vanes and a fin projecting upwards will be fixed at the end. A small set of five rotating vanes will be fixed on the starboard side of the fin, rotating vertically. These vanes will provide directional ability of the AFFC and are driven by a drive shaft from the gearbox.

According to the present invention, a heat shield is provided for the AFFS. A covering extends over the entire metal surface of the AFFS enabling it to withstand very high temperatures and to perform to specification during an extended period of high temperatures. According to the present invention, there is also incorporated a series of tanks set in the floor hull of the fuselage to contain fuel for the power plants. Additionally there will be provided a series of tanks containing fluid for the purpose of maintaining stability of the AFFS during operational procedures. The fuel tanks feed both power plants independently via header tanks above the power plants. In emergencies, these header tanks can feed the plants for a short period by gravity. There is a system provided for synchronizing the output of both power plants. Thus if one engine fails, the other will automatically compensate for the loss by increasing to full power. The maximum fuel capacity is 12,000 liters.

There is provided a cockpit situated on top of the fuselage at the front end of AFFS, overlooking the nose cone and below and forward from the air intakes of the power Plants. There is a heated windscreen with wipers and four large blistered side windows on the flight deck. The forward pair swings open slightly outward and rearward. The crew of the AFFS is thus provided with excellent observational facilities both during operational duties and when landing. The cockpit is designed to hold a crew comprising the pilot/captain, the co-pilot, navigator, engineer and two support observer/technicians.

The cockpit provides a cocoon of maximum protection for the crew in excessive heat conditions. It is also be insulated acoustically to keep extraneous noise to a minimum. The crew will have at its disposal an array of electronic surveillance equipment which will automatically report on both the circumstances immediately outside the AFFC and on the ground below. The AFFS generally functions via the judgments of the crew aided by the electronic equipment but where emergency conditions prevail, the captain can switch to fully automatic procedures.

The AFFS in the preferred embodiment has a useful payload of 800 kms. The maximum speed of the craft is 295 kph and the cruising speed will be 255kph. The service ceiling is about 4,500 meters. The maximum climb rate is 750 meters/minute.

On landing, the AFFS is supported by a non-retractable tricycle of twin wheel units. The twin nose wheels are steer able and the system has provision for heat protection during operational procedures.

The major aspect of the AFFS is the fitment of a jet turbo-fan engine producing up to 40,000kg of thrust. The thrust can be sustained over a period of time and will be used, not for the mobilization of the AFFS but for the extinguishments of fire on the ground below the AFFS.

The jet engine, weighing about 5090 kg, is fitted mid fuselage and collinear to the length of the fuselage. The air intake orifice of the jet engine will face the rear of the AFFS. It projects out beyond the rear loading entrance of the fuselage pod. A metal cowling will extend the air intake orifice under the tail boom so that the initial point of the air intake is located under the tail fin. A debris deflector is installed inside the nacelle.

There is a declination of the jet engine inside the fuselage. The declination will tilt the angle of the jet engine downward from rear to front. According to the present invention there will be provided an aperture cut into the hull floor of the pod to facilitate the protrusion of the exhaust orifice and its escape gases. The fuel tanks built into this section of the hull are modified to allow for this arrangement. There is provided a deflection mechanism at or near the aperture to allow the angle of the escaping gases to be ‘vectored’ through a quadrant running collinear to the length of the AFFS. The control of the vectoring is done from the cockpit.

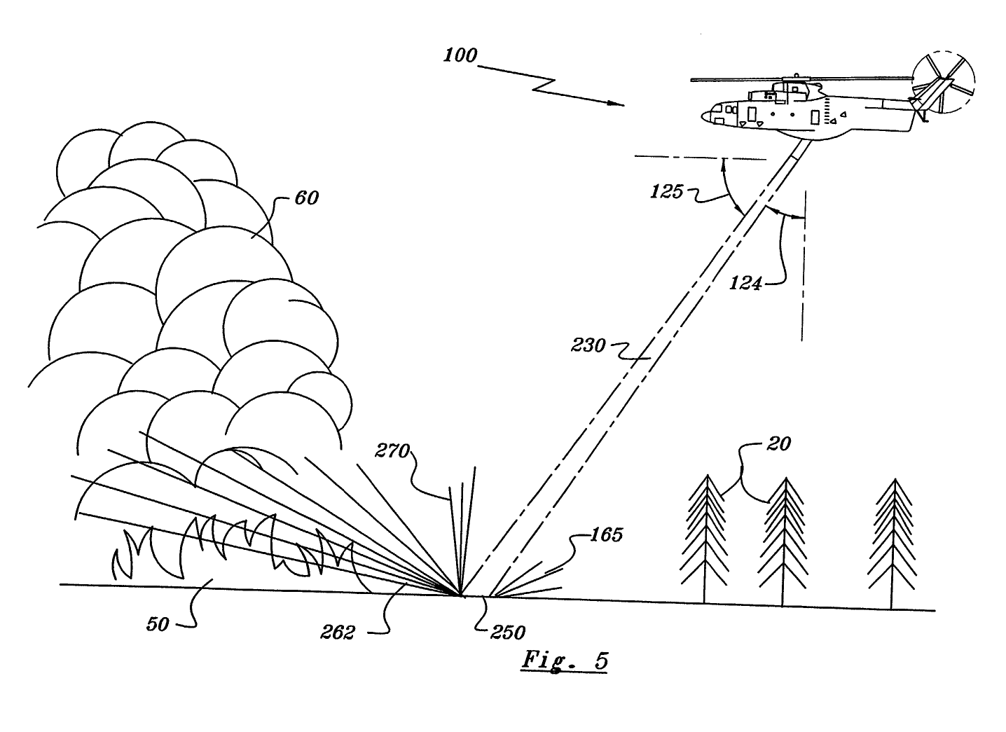

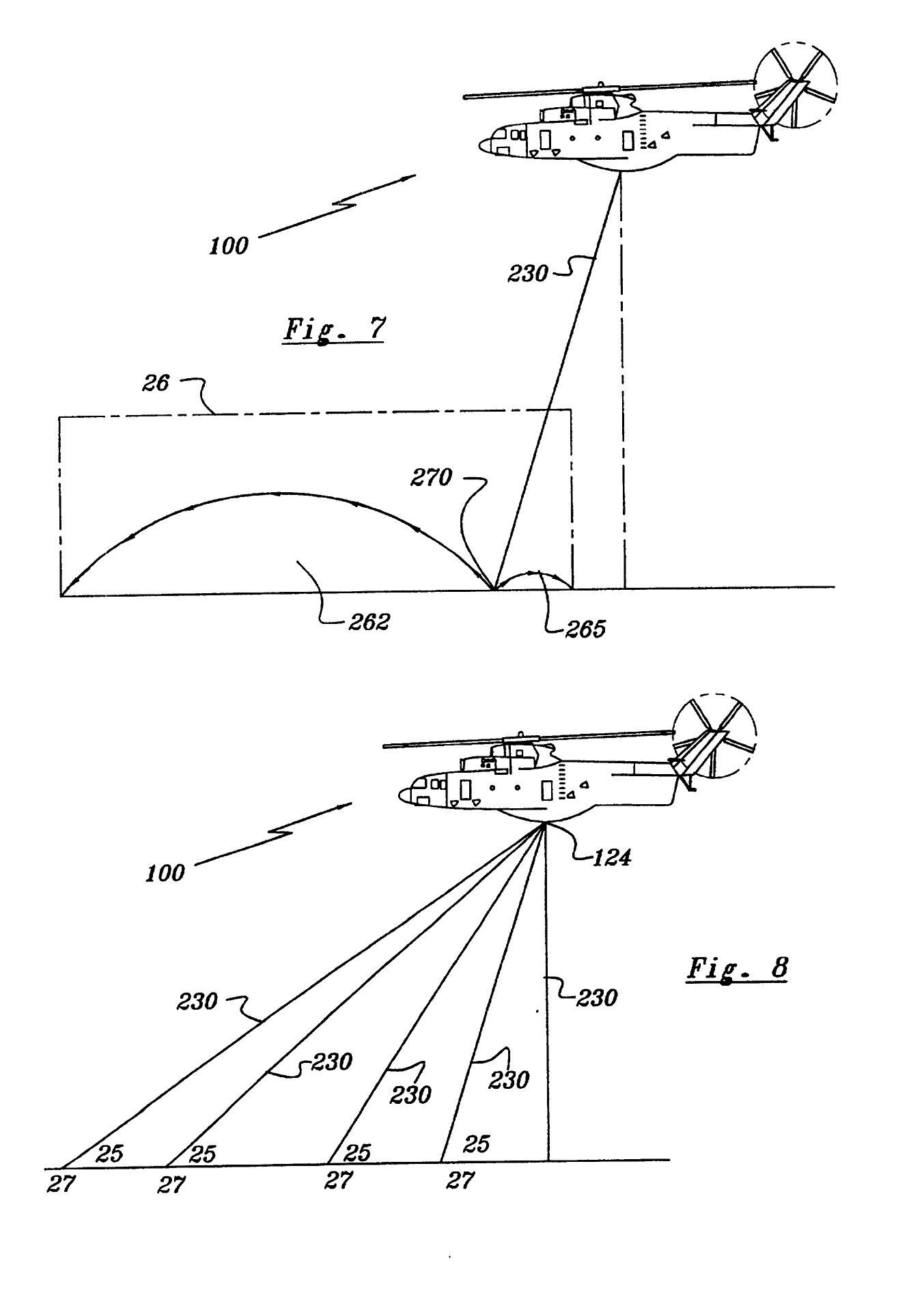

FIGS. 5&7 give some idea of the trajectory of the flying debris. It is collinear with the line of the exhaust gases escaping from the jet engine. FIG. 7 shows an elevation and section of the strike zone on flat land and the trajectories of the fire debris both behind and in front of the impact point.

According to the main provisions of the present invention, the long trajectory of the bounced jet exhaust creates a vortex or corridor through the firewall which will suck back a segment of the flames, hot debris and smoke. The resultant ‘scatter’ which is distributed throughout the strike zone falls on ground 260 which has already been burnt and the debris etc can do little further damage. The plan form of the strike zone as shown in FIG. 11 gives some idea of how the corridor works but in reality, the land where the jet exhaust impacts will rarely be perfectly flat and obstacles may lie in the path of the corridor turning its trajectory into an unknown quantity.

The main aim is to avoid sending debris towards the AFFS where it may fall on fresh foliage. This would only lead to fresh ignitions. The maximum efficiency over flat ground would only be attained from a jet exhaust escaping the AFFS at a very large angle 240. This would give a very small impact angle 25 and would be comparable to having a jet exhaust on the ground firing broadsides at the oncoming flames. This situation would be exceedingly unstable for the AFFS and it is not a provision of the present invention that the vector mechanism should be adjustable to a large escape angle 240.

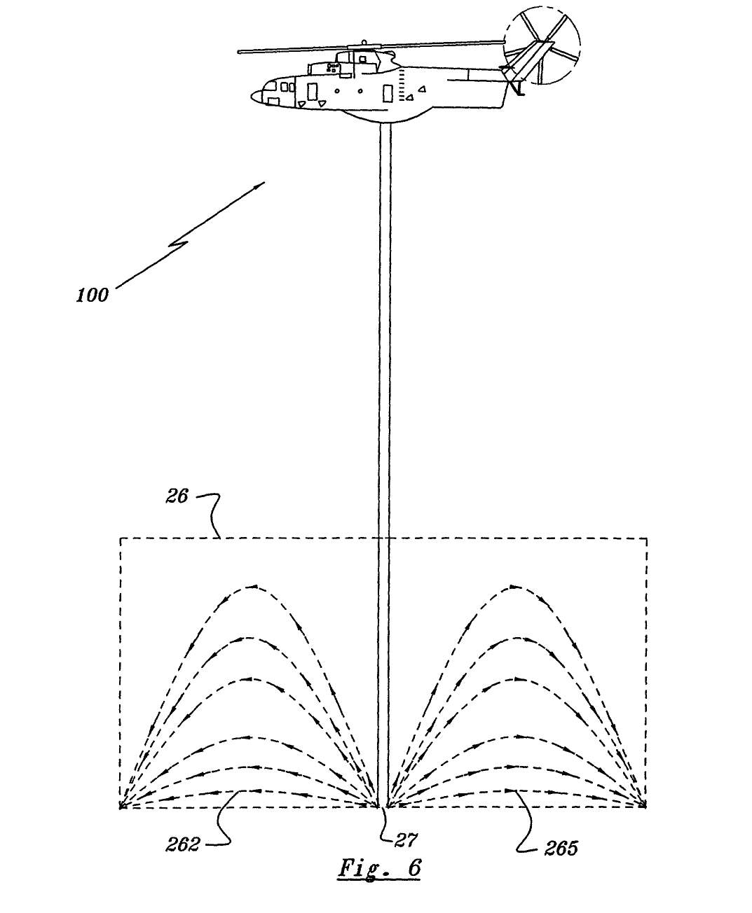

A balance must be struck between effectiveness and stability. Each situation provides opportunities for a percentage of efficiency. In FIG. 6 the escape angle is nil. The exhaust is a perpendicular escape. Particular attention to altitude must be paid in this instance, as the downdraught from the lifting vanes is considerable.

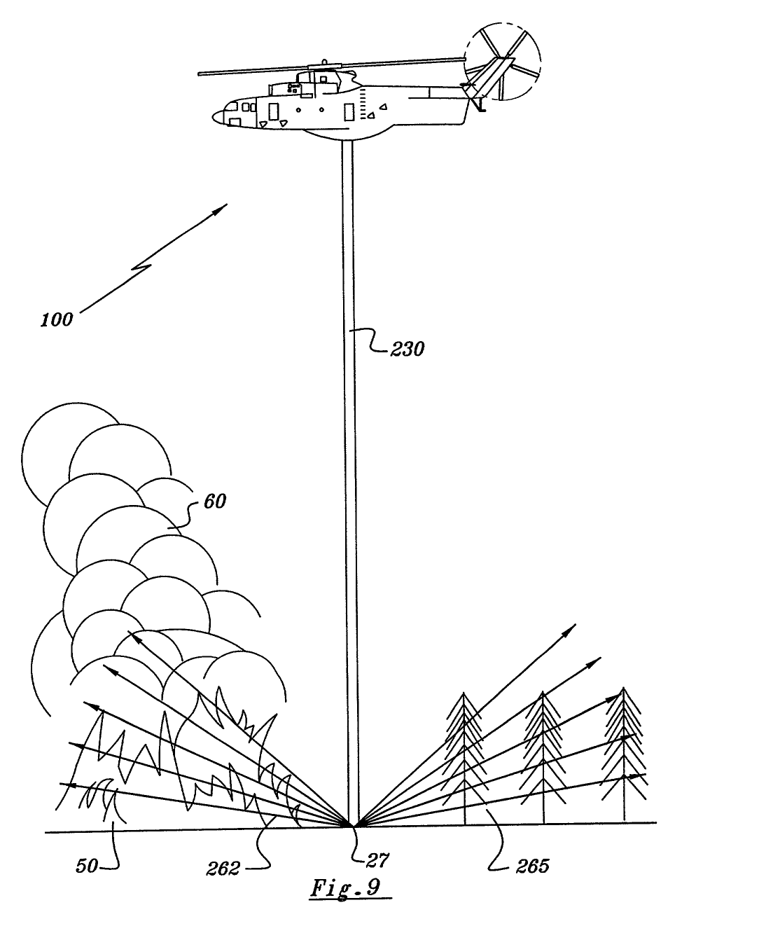

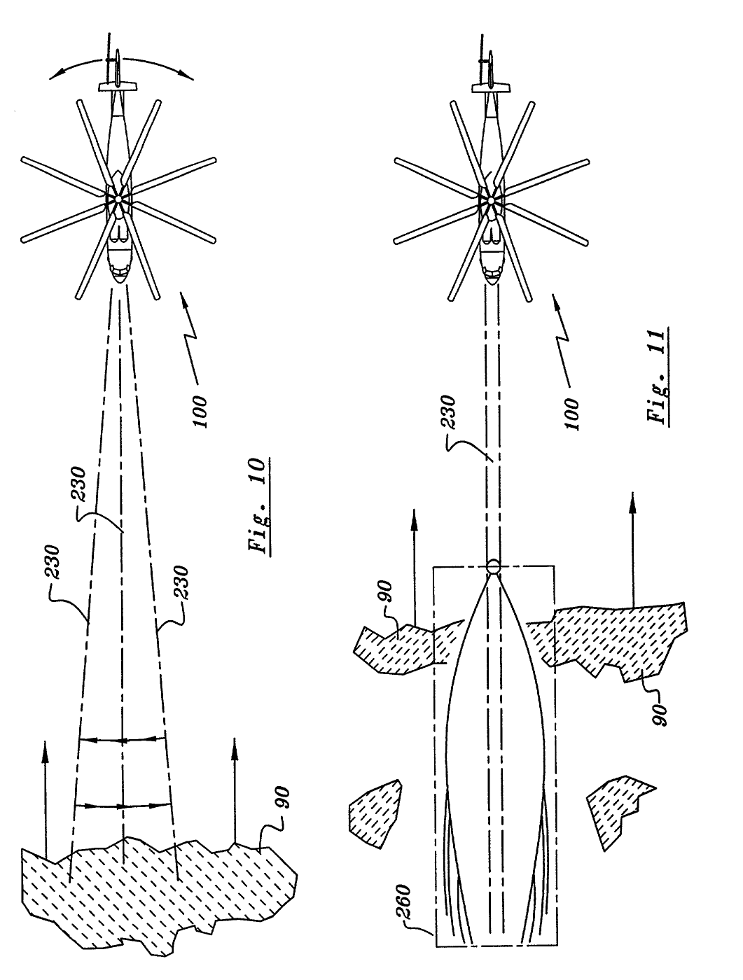

FIG. 8 shows diagrammatically, the ground gained by vectoring the jet exhaust through four forward escape angles. The ground distance is in scale to the altitude. FIG. 9 shows a near vertical escape of exhaust gases in which flaming debris may be distributed equidistantly about the impact point. The debris scatter on unburnt land may create fresh ignitions. FIG. 10 shows a plan form of the AFFC facing an advancing firewall. Also shown is the arc of the impact point where the AFFC is turned a few degrees to left and then right. FIG. 11 shows in plan form the AFFC facing a firewall and the scatter of the flame debris through the length of the strike zone.

In this situation only 50% of the impact of the jet exhaust is really being used. i.e. the 180 degrees that face the flames. It could be used in a situation where the flames are slow moving or of no great size. The AFFS would be able to adjust or creep along with the moving flames making such adjustments as to eliminate the flames as described on the previous page. Where the size or forward momentum of flame is such that it presents a problem, other tactics must be found. Continuous reference will be made to the diagnosis of the computer and any options or suggestions it recommends.

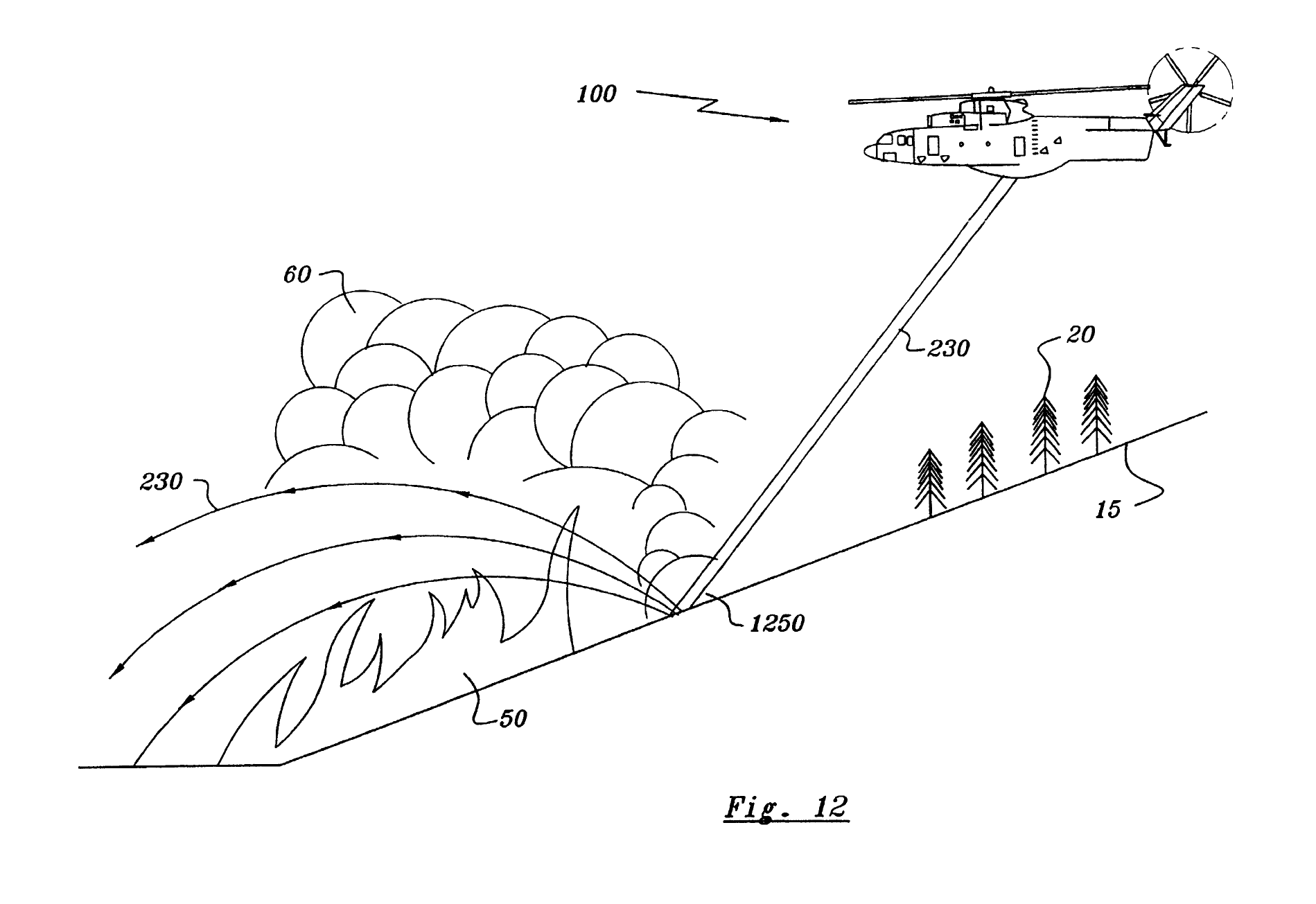

FIG. 12 illustrates an elevation through a moderate hillside where the AFFS is strafing down on a rising firewall. The AFFS can be used on varying slopes as shown in FIG. 12.

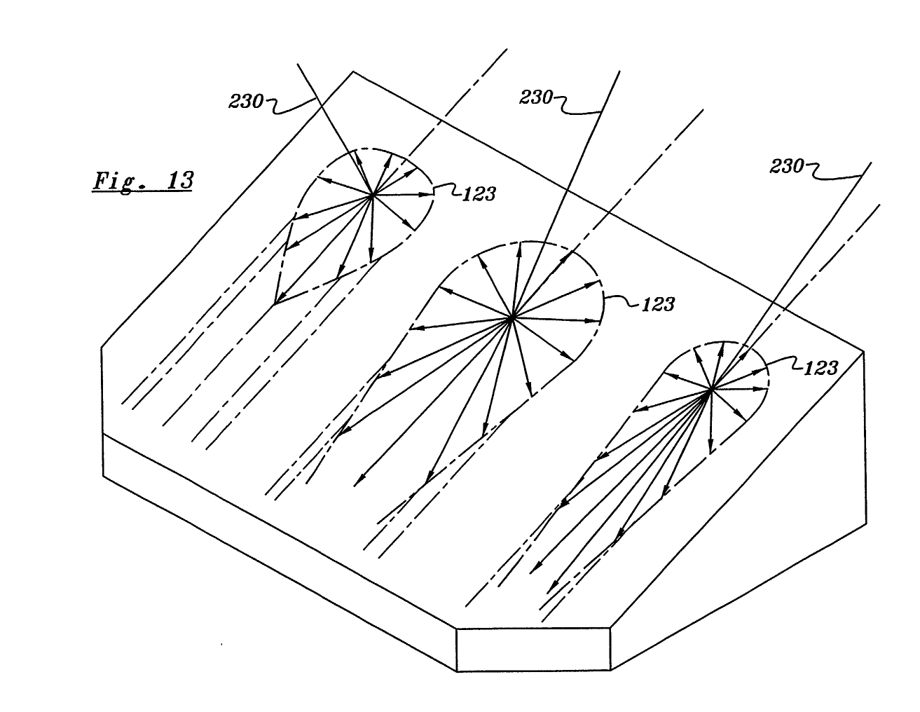

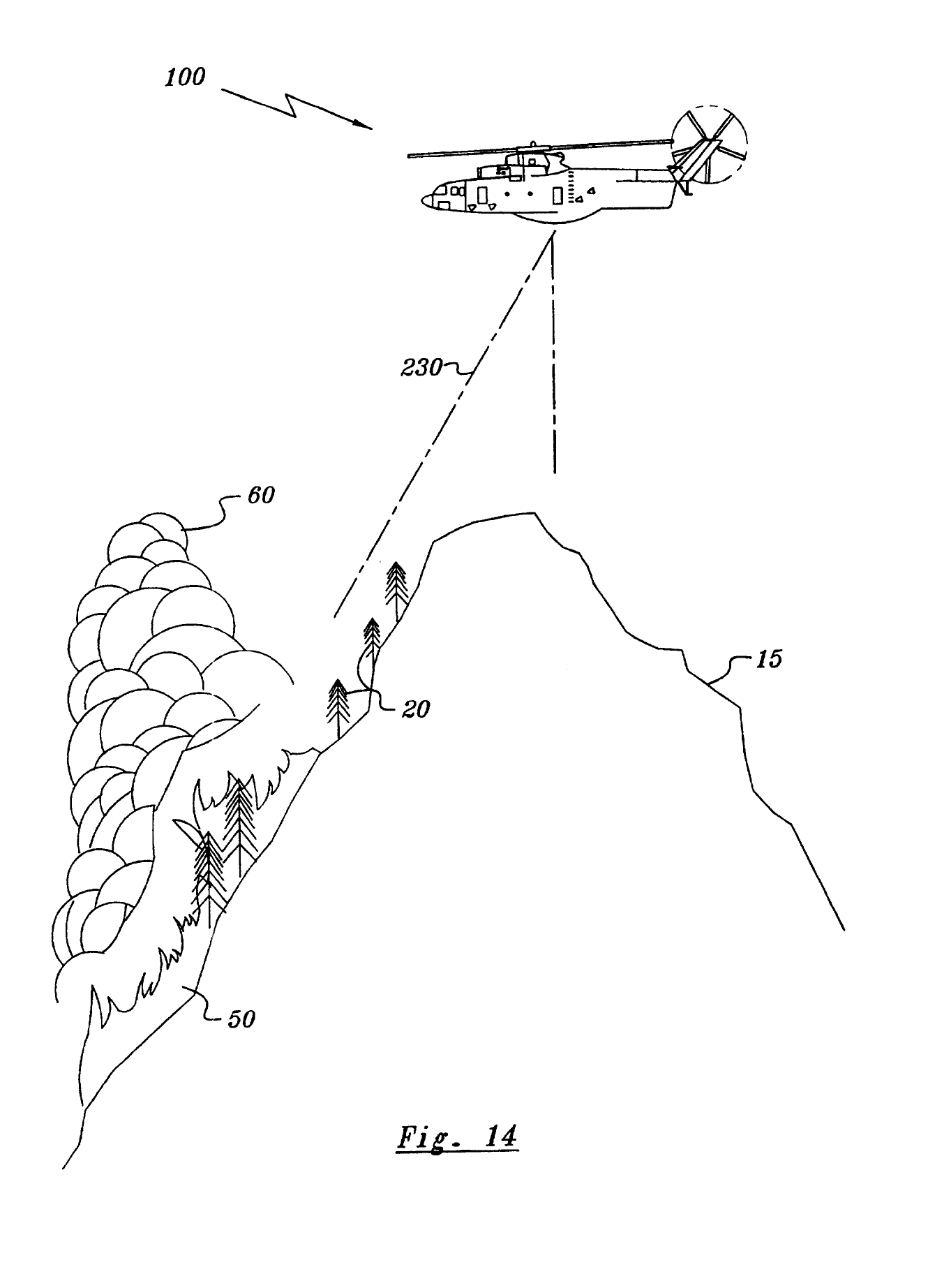

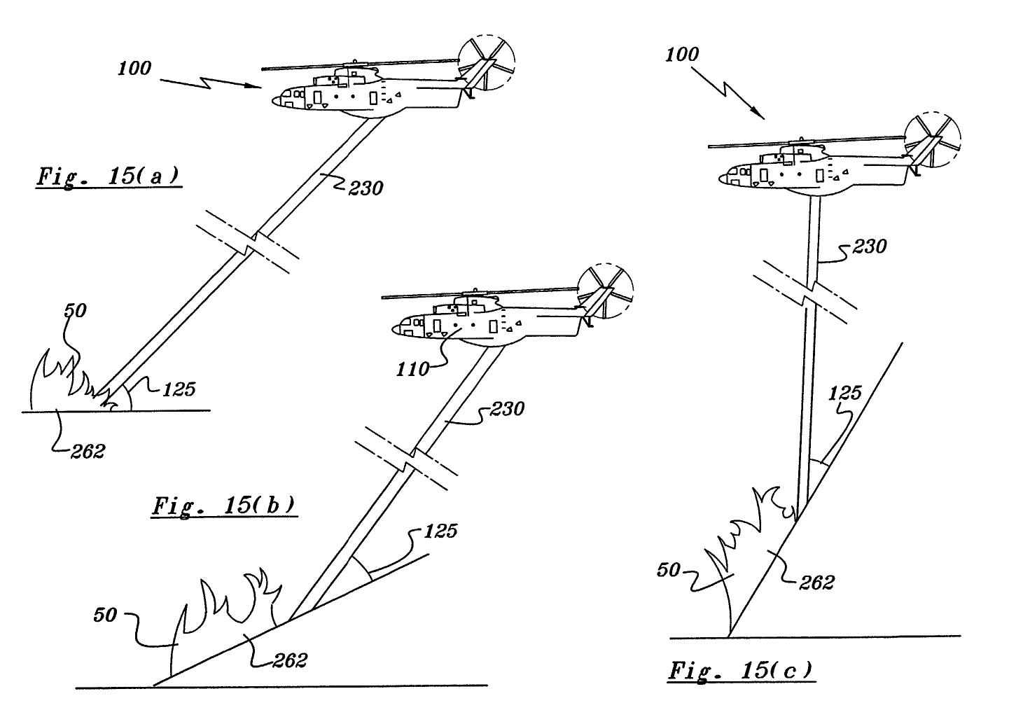

FIG. 13 shows three scatter patterns of a jet exhaust on a moderate hillside where the exhaust escapes from the AFFS at different escape angles. FIG. 14 shows an elevation through a long variable angled hillside where the AFFS is located over an adjacent valley. FIG. 15 shows how the gradients of a moderate slope and steep hillside work to the advantage of the vectored jet exhaust compared to an escape above a flat surface. In this example the slope is raised at 30 degrees to the horizontal. The tilt of the ground reduces the impact angle to 25 degrees. A comparison between a flat ground surface and a slope tilted to Comparison between a flat ground surface and a slope tilted to 30 degrees is shown in FIG. 15.

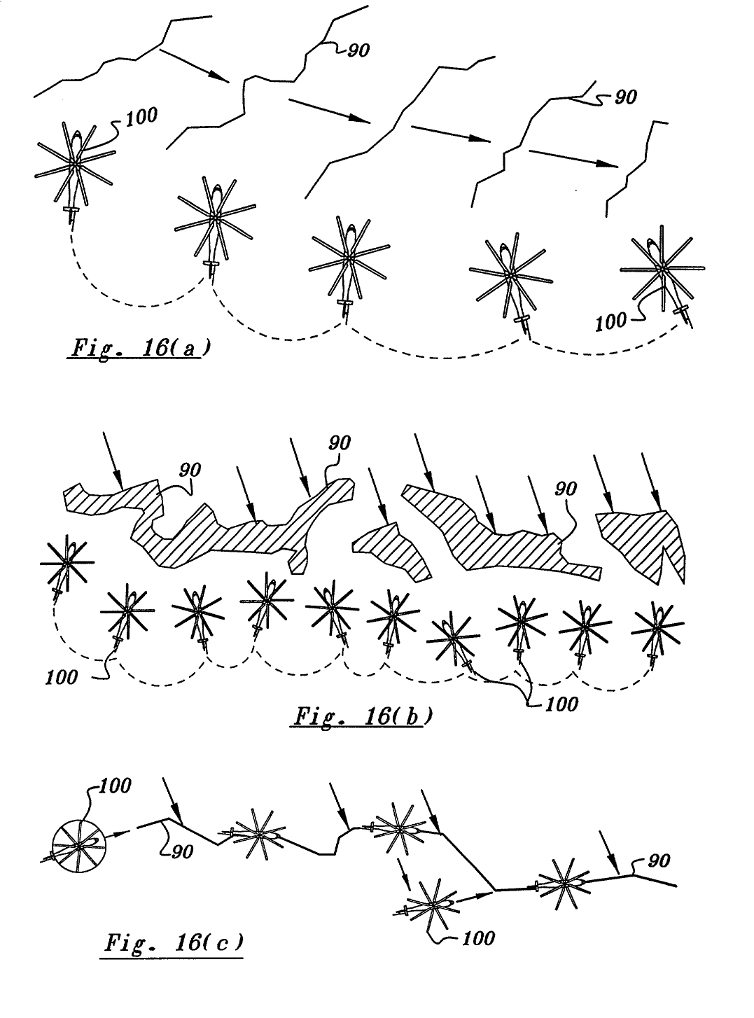

FIG. 16 illustrates some of the maneuvers an AFFS might make to optimize its potential. More particularly FIG. 16 shows a plan view of some maneuvers the AFFS makes to address an advancing firewall.

Locating the AFFS just in front of the moving fire line might not be an effective move if the wind is driving the flames nor is it the best location if the smoke plume is riding in advance of the flames. In this instance, a location at the edge of the flames is preferable so that the fuselage of the AFFS is collinear to the line of the flames. The AFFS adjusts itself to right while moving forward at the fire line. The exhaust of the jet will strafe at the flames side on in a diagonal sliding maneuver. Where the fire line bends or breaks, the AFFC will be able to cope more efficiently than if the fires are a collection of broken patches of varying sizes.

In this situation the AFFS relies implicitly on the computer particularly if the fires are forest fires and the flames are spreading from crown to crown. It is possible for the AFFC to operate from within a fire zone. If the AFFS can locate over ground which is already burnt, the downdraught of the rotor vanes will have no ignition effect and the jet exhaust can be trained on the flames around as usual.

There are many situations where the AFFS might be called on to participate but only a few are described here for a landscape where the ground is predominantly flat.

The advantage of operating above a slope can now clearly be seen. In order to obtain an impact angle of 35 degrees on a flat surface it would be necessary to secure an escape angle 24 of 55 degrees. An extreme angle that would tend to make the AFFC unstable. A slope or hill thus enhances the efficiency of the AFFS operating potential. At this small impact angle 125, the ground offers less resistance to the power of the jet exhaust as it impacts with the ground.

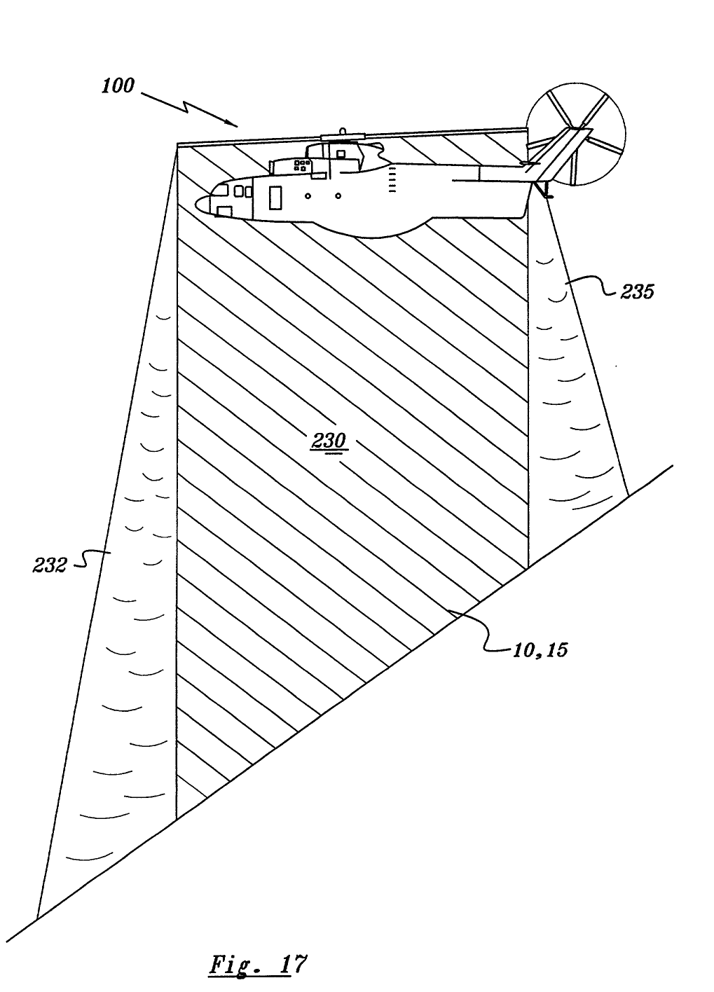

The trajectory is both lower and longer on a moderate slope than on a flat surface. As with hot air, flames will tend to rise up a slope and the captain will aim to locate, if possible, at the upper end of the slope facing down at the lower end. The smallest impact angle 125 can thus be obtained. Where the AFFS is operating above a long slope, another factor must be considered. Because of the enormous power of the downdraught emanating from the rotor vanes 130, the captain must ensure the altitude is sufficient to avoid fanning any areas of potential ignition on the slope below. FIG. 17 illustrates the effect on a slope, showing the turbulence thrust downwards at the vane tips. This turbulence reaches the ground more quickly on the upper levels of the slope and with more force. At the lower end the force may be less but is more spread out and any patches of simmering foliage may be fanned into a blaze.

FIG. 14 gives one instance where the AFFS can operate at a low altitude without any concern regarding the downdraught. This occurs when the AFFS can be sited on the far side of the apex of the hill where the fires are burning. The downdraught from the vanes is now separated from the fire zone and has no effect on areas of potential ignition. With a large enough escape angle 240 , the jet exhaust may be able to strafe a corridor down large portions of a hillside without ever impacting the ground.

The captain of the AFFS can approach the moderate slope guided by the avionics equipment and computer. The advancing firewall may be held by the AFFC remaining in one location, turning to left and right as shown in FIG. 10. The scatter of the flame debris in the strike zone 260 assumes different shapes depending on the height of the AFFS. And also on wind speed and direction. FIG. 3 shows how the scatter alters with the change in impact angle 25.

The smaller the impact angle, the longer is the scatter pattern. The captain may opt for a larger escape angle 240 and turn the AFFS to face across the slope of the hillside and strafe the rising firewall on the move. This would be an appropriate action where the firewall was spread along a wide front and rising rapidly. The AFFS would in this situation be sited over or nearly over the leading edge of the firewall.. It can patrol across the slope from one side to another, altering altitude where necessary and turning 180 degrees, restrafe the line, extinguishing any parts of the firewall that were not put out on the first run. It is a major provision of this invention that its ability to maneuver over firewalls on difficult slopes obviates the risk to fire crews who might otherwise be expected to enter these dangerous areas. Many large-scale fires occur in mountainous areas and the impracticality of sending crews into these areas means the fires are just left to burn out by themselves.

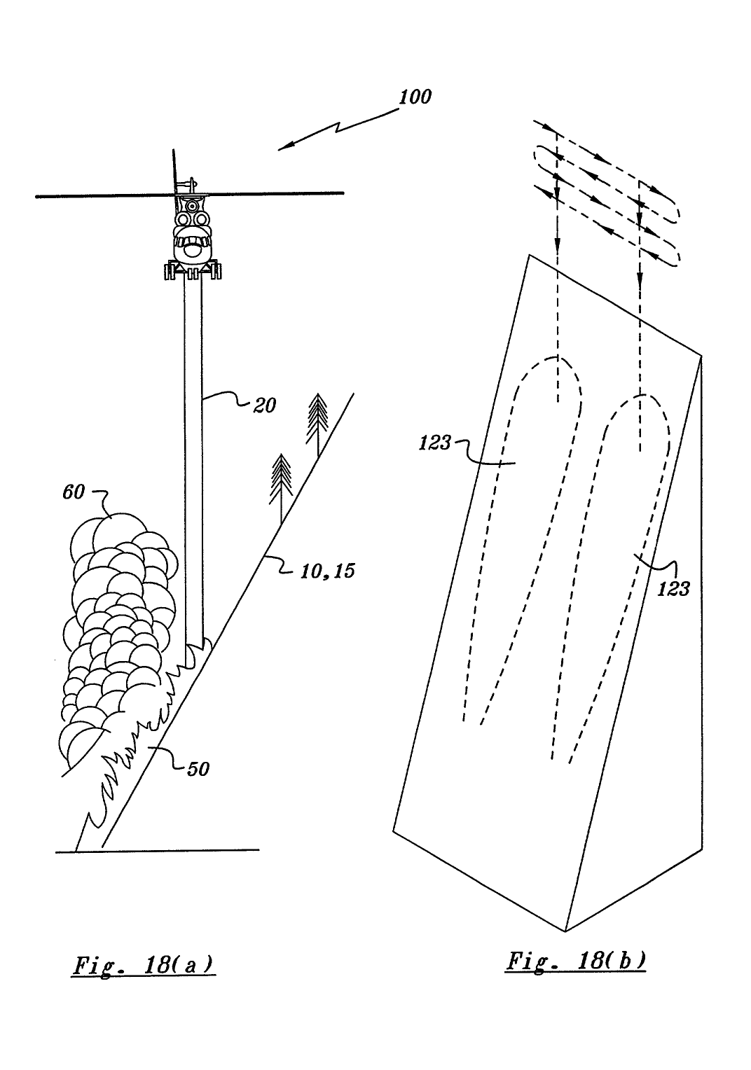

FIG. 18 illustrates the AFFS operating above a steep or near vertical slope. In these circumstances the captain will occasionally make use of a perpendicular escape for the jet exhaust gases.

The impact angle 25 becomes acute when a 0 degree escape angle 24 encounters such a slope. The jet exhaust gases 230 are only slightly deflected from the original path and are virtually punching sideways at the firewall. The corridor of extracted flame debris and exhaust gases will continue if unrestricted by large trees and boulders, for many hundreds of feet down the hillside, landing on previously burnt ground. According to this invention, the AFFS can optimize its potential on a steep slope as depicted in FIG. 18.

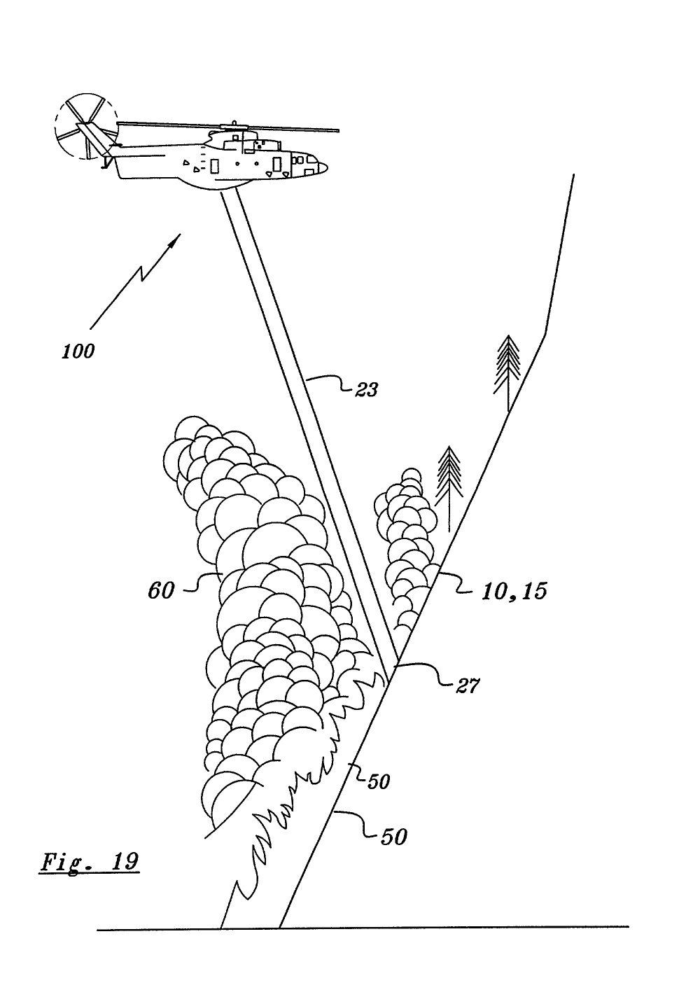

The combined effects of near vertical hillside aided by gravity enable the force of the jet exhaust to deal with the worst of mountain wildfires. Where excessive smoke becomes a problem, the AFFC has only to move away from the location and take up the new attitude as shown in FIG. 19. The escape angle 240 is now approximately 20 degrees and the impact angle switches to the reverse side of the impact point 250. The corridor down through which the flaming debris is scattered will still be extensive and efficient. Where the AFFS is cruising above a near vertical hillside using a perpendicular jet exhaust escape, the Captain's vision may be restricted and the observer technicians may be assisted by the blistered rear windows in the cockpit 120. The AFFS may cruise back and forth above the steep hillside as delineated in FIG. 18 (b)

FIG. 19 shows an elevation through a steep hillside where the AFFS as moved away from the excessive smoke plumes and is facing the hillside.

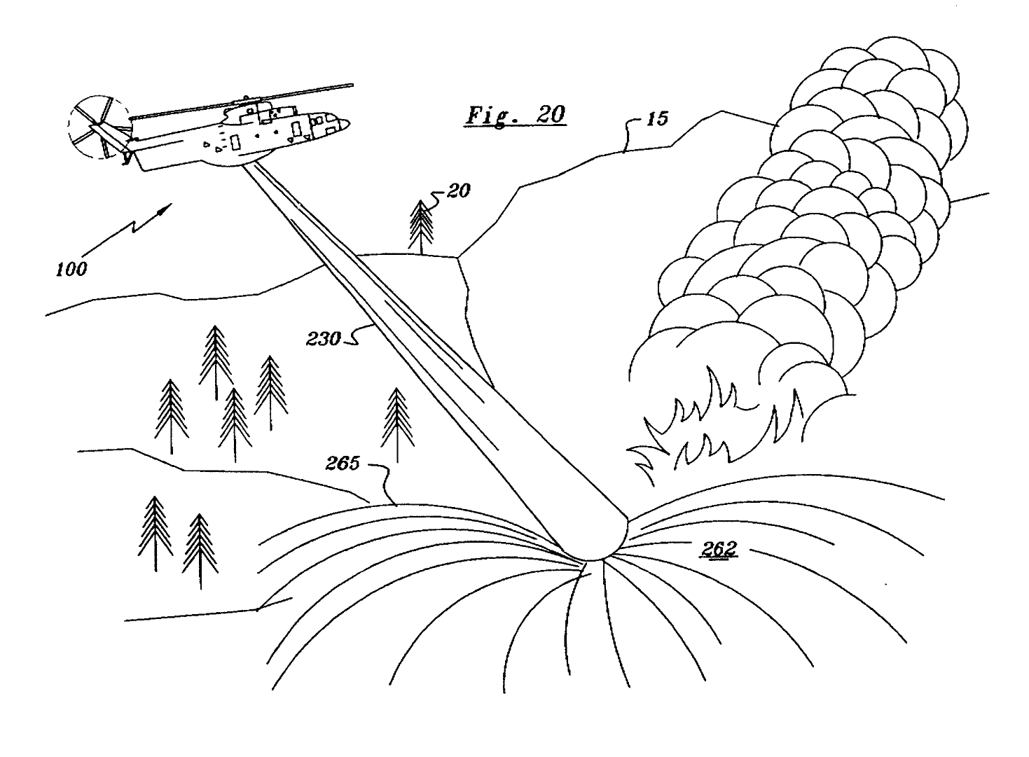

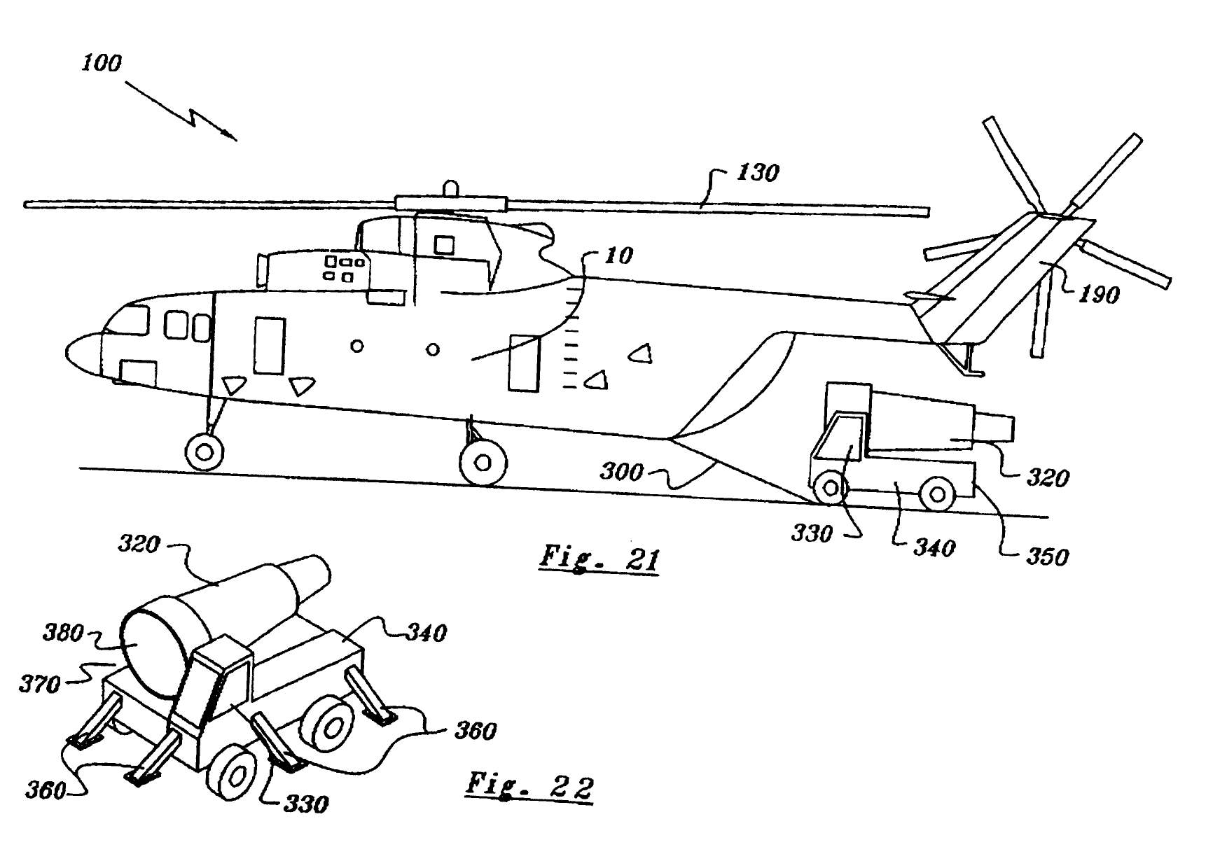

FIG. 20 shows the AFFS in action and how versatile it can be in various types of terrain and situations.

### ALTERNATE EMDBODIMENT—1

A further embodiment of the present invention is described below in which the jet engine, fixed in the fuselage pod will be removed and replaced by a jet engine FIG. 22 of a smaller specified thrust, mounted on wheeled, mobile vehicles. The intake cowling 200 is removed and the rear entry to the AFFS is secured by two clamshell doors 310.

There is provided a motor 350, connected to the wheels of the mobile vehicle and a cab 330 mounted at the front and side of the mobile where the driver sits. The jet engine may be sited on one side of the top surface of the mobile. It is secured to the surface by hydraulic arms 370 which can be used to alter its location on the surface. The outgoing or exhaust orifice 380 of the jet engine will be sited at the front or cab end of the mobile. Behind the cab, fuel tanks 340 may be secured and fitted with a heat shield. Extending stabilizer legs 360 can be located in a folding storage position on all four sides of the mobile.

The fuselage 110 of the AFFS is provided with an extendable ramp 300 which lowers to the ground when the doors 310 are open. The mobiles are loaded and unloaded by means of the ramp. The mobiles are loaded by means of a winch fixed in the fuselage so that the cab 330 is facing the ramp and ready for a quick exit. Two mobiles may be loaded into the pod at one time. With the mobiles loaded, the AFFS lifts off and proceeds to a suitable landing site near the fire zone.

The clamshell doors 310 are opened and the ramp 300 extended. Locks used to secure the mobiles in flight are released and the mobiles exit the AFFS down the ramp. The mobiles are now driven into position as required with the exit orifice of the jet engine facing at the oncoming firewall. The stabilizing legs are retrieved from the storage position and fixed into the ground.

The mobile is now secured and the jet engine ready to be fired up. The driver leaves the cab and the operation can be controlled from a distance by remote control. The exhaust gases leave the outlet orifice 380 and strike the oncoming firewall. If required, the jet exhaust can be reduced and the mobile moved to a new location.

The direction of the jet exhaust can be arced across a firewall segment by use of the hydraulic arms 370. The mobile jet engine can thus be used and moved easily from location to location as required. When the technicians judge it time to relocate, the mobile is easily made ready to move and driven off or collected by the AFFC and flown to a new fire zone.

### ALTERNATE EMBODIMENT—2

This invention offers numerous other applications. Following paragraphs describe the problems of snow and icing and the solution of snow removal and deicing provided by AFFS.

Snow and ice frequently cause major problems for both private individuals and public authorities. Airport runways are deemed to be unserviceable after or during heavy snowfalls. Snow ploughs are the main means of keeping runways and perimeter service lanes open but the huge acreage is often too much for the machines and the only option is to close the airport.

Where snow falls continuously on a highway, big drifts build quickly causing major disruptions where the traffic flow is heavy. Snow ploughs are the accepted means to disperse the drifts but it can be a slow process with snow piling up behind the machine faster than it can be cleared in front. Ice is on the road surface can quickly bring about a blockage when vehicles lose their grip on the surface and cannon into each other.

Roads are frequently laid on the floor of valleys where mountains rise up on either side. They may also be sited halfway up a mountainside. In winter conditions where snow builds up in the higher slopes of the mountains, such roads are subjected to avalanches which may dump many feet of snow on a road surface. The snow ploughs must then get to the site where many hours of work are required to clear the road for use again.

Ice builds up thickly on exposed areas of marine craft. Sometimes the build-up on rigging is enough to capsize the vessel. Aircraft are also susceptible to ice. Outdoors machinery may freeze up to an extent that it becomes inoperable. It may be sited in locations where access is difficult or even impossible to get at.

Power lines and their supporting pylons become vulnerable to ice during winter conditions. In Canada during the winter of 1998, a series of ice storms quickly put a huge volume of ice on one large area of cable and pylons. This resulted in pylon buckling or collapse and cable snappage. Electricity supplies were curtailed over a large urban region with all the attendant disruption to business and industry.

Radio and TV masts are frequently located on highly exposed or mountainous sites where severe icing renders transmission quite impossible. Where ice builds up on bridges, it can become hazardous to permit the passage of both vehicles and pedestrians.

In northerly latitudes ice may pack up around vessels restricting all further movement. This can prove very costly to the vessels owners if the restriction extends for any length of time. Where heavy falls of snow occur at airports, the runways and peripheral tracks can become so clogged that no aircraft movements are permissible. The AFFS can cruise above the runways and taxiways at low altitude and clear the snow using the power of the jet exhaust. In addition, the heat of the exhaust will melt a considerable amount of snow and there will be a secondary effect of the heated up tarmac which will melt any snow falling on it for a while thereafter. Ice will be cleared and again the Heating effect will prevent ice from easily forming again. This technique can clear a runway much faster than a snowplough. Continuous clearance between aircraft take off and landing will ensure the airport stays open for a much longer then might be possible using snow ploughs.

As an alternate embodiment the AFFS clear motorways of snowdrifts. Where flying conditions permit, the AFFS may cruise above a snow or ice blocked road and blast the material with either perpendicular or forward vectored jet exhaust. The AFFS can clear affected roadways much faster than a snowplough and roads may therefore be kept in use for longer periods than when snow is moved using traditional methods. The depth of a snowdrift may impair the efficiency of a plough but the AFFS operates in all but the worst blizzards.

Avalanches in mountain areas can be started with surgical precision using the jet exhaust of the AFFS. Where an avalanche has already occurred, the AFFC can be brought overhead and the force and heat of the jet used to disperse what may be a very deep layer of snow. Because the surveillance equipment can see through the snow from above, it is easy to detect any vehicles or people trapped beneath.. The AFFS can clear roads buried under avalanche snow in a much shorter time than snowploughs.

Power lines and their supporting pylons will be freed from a girdle of ice or snow by using the jet exhaust of the AFFS as a heat source rather then actual thrust. The exhaust will be activated at a predetermined height and any ice build up on the cables or metal pylons will melt due to the proximity of the heat. This method can also be used to clear radio and TV masts by allowing only a small quantity of heat to filter round the equipment. The AFFS would operate above the masts using a reduced vertical thrust. In the case of very tall masts, a low thrust can be used with a forward vector to get heat to the lower segments of the mast. Bridges and buildings may be de-iced using the ‘offset heat’ method. Outdoor machinery prone to icing may be cleared for use in some situations especially when located in inaccessible locations. Marine craft may suffer from extreme ice formation but the AFFS may be able to melt it before the weight renders the craft unworkable. In northern latitudes vessels are often locked into ice packs. The AFFS may be brought over the ice and the heat and thrust of the jet exhaust used to break up the ice and free the vessel.

### OPERATION

The operation and use of the fire fighting system of this invention is simple and even intuitive. Nonetheless the inventor suggests the following protocol.

The AFFS receives a call for assistance at a fire zone and using its piston engines 117 and rotor vanes 130, it lifts off and heads for the zone. Information describing conditions at the fire zone is relayed to an on board computer in the AFFS enroute. This gives the crew some idea of what to expect when the AFFS arrives at the fire zone. On arrival, an array of avionics located mainly in the nose cone 16 will assess conditions. It will scan the lie of the land in the area beneath the AFFC producing topographical layouts with the gradients of all relevant slopes and hillsides. Flame heights are measured. Also length, speed and drift of all firewalls in the vicinity is affected accordingly. Wind speed and direction will be a major factor during operations of the AFFS as will the size, drift and maximum altitude of smoke plumes. The avionics in the nose cone 160 is able to penetrate a thick smoke plume and accurately plot the size and direction of any flames concealed beneath. When the available information has been collated and fed into the computer, it will make a diagnosis and from the bank of possibilities stored in its memory.

It even recommends a starting point to the crew and projects various options with respect to any fire crews that may be on the ground below. The AFFS now approaches the broadside of the firewall section designated by the computer which is moving across an area of flat land FIG. 10 plan view. The fuselage 110 is angled at the firewall selected by the computer. The jet engine 121 previously started and warmed is projecting its exhaust gases 230 through the outlet orifice at low revs. The captain begins to descend to the altitude recommended by the computer. A preferred altitude may be 150′ And from the firewall to a point under the AFFS is 400 feet. The computer now recommends the jet exhaust gases 230 are vectored. Using the vector mechanism 220 located near the exhaust orifice, the jet exhaust gases are now reset so that the impact point 250 of the exhaust gases as they strike the ground is well forward of the point on the ground below the AFFS. The AFFS now stabilizes at the preferred altitude and the power of the jet engine 121 is increased. Simultaneously, the power plants piston engine 117 controlling the rotor vanes 130 are decreased while the thrust from the auxiliary orifices 119 at front and rear prevents any pitch and yaw. The computer also makes any necessary changes to the fluid stability tanks 150. The AFFS is now held in position by the overhead rotors and also the jet exhaust gases provide some uplift. The massive bulk i.e. weight of the AFFC is the factor which provides stability within this operation. No smaller craft would be capable of counter weighting the forces generated by the exhaust of a jet engine.

The advancing fires now close on the impact point 250 where the jet exhaust gases are striking the ground in front of the firewall. The flames begin to react to the force of the jet exhaust bouncing into an extended trajectory after striking the ground. The line of flames begins to fragment and an arch of flaming debris rises from the ground and is hurled back into the area from which the flames have just come. It will disperse over a wide area but as much of the foliage has already been consumed by the flames, it will not matter. This is because it will be unable to ignite fresh fires. The AFFS now turns slowly a few degrees to the left. The impact point 250 moves through an arc of about 40′ and stops. The AFFS now turns a few degrees to the right and stops. From left to right the impact point 250 made by the exhaust of the jet engine has now moved along a line some 80′ to 100′ in length. The approaching firewall now has a wide gap between flames where the jet exhaust has extinguished the fire. By repetition of these tactics the AFFC can work along an entire line of fire. The power of the jet is decreased and the AFFS advances and relocates to the next segment of the firewall. The inventor has given a non-limiting description of the Air Borne Fire Fighting system of this invention. Due to the simplicity and elegance of the design of this invention designing around it is very difficult if not impossible. Nonetheless many changes may be made to this design without deviating from the spirit of this invention. Examples of such contemplated variations include the following:

1. The shape and size of the various members and components may be modified.

2. The power, capacity, aesthetics and materials may be enhanced or varied.

3. The fuselage may be of strong lightweight rigid material and optionally aerofoil shaped.

4. Additional complimentary and complementary functions and features may be added.

5. Additional complementary functions may be added.

This system could also shift snow and ice clear airports and highways. Indirect heat from exhaust may deice TV & radio masts. Also clear ice buildup on pylons and cables to prevent topple over. Thus it can be an all year all season machine.

Other changes such as aesthetics and substitution of newer materials as they become available, which substantially perform the same function in substantially the same manner with substantially the same result without deviating from the spirit of the invention may be made. Following is a listing of the components used in this embodiment arranged in ascending order of the reference numerals for ready reference of the reader.

| | |
|---|---|
| 010 = | Ground - Generally Horizontal |
| 015 = | Hill - generally steep incline |
| 020 = | Property such as trees on fire |
| 050 = | Flames |
| 060 = | Smoke |
| 090 = | Firewall 90 |
| 099 = | AFFS or Fireaxe system generally |
| 100 = | Fire Fighting Helicopter generally |
| 110 = | Fuselage of the aircraft |
| 115 = | Fuselage Pod |
| 117 = | Front Piston Engine |
| 119 = | Rear Piston Engine |
| 120 = | Cockpit |
| 121 = | Jet engine |
| 122 = | Jet Blast Interface |
| 123 = | Jet Blast Conduit Member |
| 124 = | Angle of Blast attack with respect to vertical |
| 125 = | Angle of Blast attack with respect to Horizontal |
| 130 = | Helicopter Rotor Blade or virtual disk formed thereby |
| 140 = | Rotor engines |
| 150 = | Internal Stabilizing Tanks |
| 160 = | Nose Cone |
| 170 = | Air Intake |
| 190 = | Tail rotor |
| 200 = | Intake Cowling |
| 220 = | Vector mechanism near exhaust orifice |
| 230 = | Jet Exhaust & Down draught |
| 232 = | Forward Turbulence |
| 235 = | Rear Turbulence |
| 250 = | Point of Impact of jet exhaust |
| 260 = | Horizontal, ground or hill component |
| 262 = | Forward component of jet exhaust |
| 265 = | Rear reflected component jet exhaust |
| 270 = | Vertical reflected component of jet exhaust |
| 300 = | Ramp |
| 310 = | Shell Door |
| 320 = | Jet Engine on Fire truck |
| 330 = | Cab of fire truck |
| 340 = | Fire truck |
| 350 = | Motor |
| 360 = | Stabilizing Arms with Pads |
| 370 = | Hydraulic arms |
| 380 = | Exhaust orifice |

### DEFINITIONS AND ACRONYMS

A great care has been taken to use words with their conventional dictionary definitions. Following definitions are included here for clarification.

| | |
|---|---|
| 3D = | Three Dimensional |
| Aerofoil = | A body shaped to produce lift as it travels |
| | through the air. |
| Angle of Attack = | The angle of tilt of an aircraft wing whereby |
| | leading edge is higher than the trailing edge. |
| DIY = | Do It Yourself |
| Integrated = | Combination of two entities to act like one |
| Interface = | Junction between two dissimilar entities |
| Retro-Thrust = | Additional trust or drag provided by engines in |
| | reverse, which helps in reducing the STOL distance. |
| Symmetrical = | The shape of an object of integrated entity |
| | which can be divided into two along some axis through the object or the |
| | integrated entity such that the two halves form mirror image of each other. |
| Turbulence = | Break up of laminar airflow. Excessive angle of |
| | attack leads to boundary layer separation of laminar airflow and hence the |
| | turbulence. |
| V/STOL = | Vertical/Short Take Off and Landing |

While this invention has been described with reference to illustrative embodiments, this description is not intended to be construed in a limiting sense. Various modifications and combinations of the illustrative embodiments as well as other embodiments of the invention will be apparent to a person of average skill in the art upon reference to this description. It is therefore contemplated that the appended claim(s) cover any such modifications, embodiments as fall within the true scope of this invention.

The inventor claims:

1. An airborne fire fighting system comprising:
a) a vertical lift aircraft having semi-monocoque, pod and tail boom fuselage and a hull;
b) a heat shield encompassing said fuselage;
c) a plurality of fluid filled tank means set in the hull of said fuselage for maintaining stability; and
d) adjustable tiltable fire extinguishing means.

2. The airborne fire fighting system of claim 1 where in said adjustable tiltable fire extinguishing means comprises at least one turbo-fan jet engine.

3. The airborne fire fighting system of claim 2 where in said adjustable tiltable fire extinguishing turbo-fan jet engine is declined into said fuselage and includes the means for tilting the angle of said jet engine downward from rear to front

4. An airborne multipurpose system comprising:
a) a vertical lift aircraft having semi-monocoque, pod and tail boom fuselage and a hull;
b) a heat shield encompassing said fuselage;
c) a plurality of fluid filled tank means set in the hull of said fuselage for maintaining stability; and
d) a multipurpose adjustable exhaust thrust.

5. The airborne multi purpose system of claim 4 where in said adjustable exhaust thrust comprises at least one turbo-fan jet engine.

6. The airborne multipurpose system of claim 5 where in said turbo-fan jet engine is declined into said fuselage and includes the means for tilting the angle of said jet engine downward from rear to front

7. The airborne multipurpose system of claim 4 wherein said multipurpose adjustable exhaust thrust is adapted for removing ice and snow from runways, roadways and railways.

8. The airborne multipurpose system of claim 4 wherein said multipurpose adjustable exhaust thrust is adapted for removing ice and snow from power lines.

9. The airborne multipurpose system of claim 4 wherein said multipurpose adjustable exhaust thrust is adapted for melting ice around ice locked ships.

10. The airborne multipurpose system of claim 4 wherein said multipurpose adjustable exhaust thrust is adapted for search and rescue of people trapped in an avalanche.

11. The airborne multipurpose system of claim 4 wherein said multipurpose adjustable exhaust thrust is adapted for causing an avalanche with surgical precision.

12.The airborne multipurpose system of claim 4 wherein said multipurpose adjustable exhaust thrust comprises a jet engine mounted on a mobile unit.

13. The airborne multipurpose system of claim 4 wherein said vertical lift aircraft includes means for easy loading and unloading of said mobile unit.

14. The airborne multipurpose system of claim 13 wherein said means for easy loading comprises a winch for quick loading of said mobile into said fuselage of said airborne multi purpose systems and said easy unloading means comprises a ramp for quick exit of said mobile unit.

15. The airborne multipurpose system of claim 12 wherein said mobile unit is remotely controllable.

16. A process of providing hot air thrust on demand and with precision for accomplishing an objective comprising mounting a jet engine in a vertical lift aircraft.

17. The process of providing hot air thrust on demand and with precision of claim 16 wherein said jet engine is mounted an a mobile unit with easy loading and unloading into said aircraft and wherein said mobile unit is remotely controllable.

18. The process of providing hot air thrust on demand and with precision of claim 16 wherein said objective is to extinguish fires.

19. The process of providing hot air thrust on demand and with precision of claim 16 wherein said objective is ice and snow removal from runways, roadways, railways and power lines.

20. The process of providing hot air thrust on demand and with precision of claim 16 wherein said objective is search and rescue by artificial creation, removal and manipulation of avalanches.
